(19) United States
(12) Patent Application Publication
(10) Pub. No.: US 2026/0146475 A1
(43) Pub. Date: May 28, 2026

(54) Locking Mechanism and Locking Apparatus

(71) Applicant: AAC ACOUSTIC TECHNOLOGIES (SHENZHEN) CO., LTD., Shenzhen (CN)

(72) Inventors: Songtao Li, Shenzhen (CN); Qinghua Lin, Shenzhen (CN); Hongyan Tao, Shenzhen (CN)

(21) Appl. No.: 19/174,964

(22) Filed: Apr. 10, 2025

Related U.S. Application Data
(63) Continuation of application No. PCT/CN2024/134104, filed on Nov. 25, 2024.

(51) Int. Cl. E05B 57/00; E05B 9/00

(52) U.S. Cl. CPC E05B 57/00; E05B 9/00

(57) ABSTRACT

Disclosed are a locking mechanism and a locking apparatus. The locking mechanism is operable to securely lock a detachable attachment. A bolt is connected to a drive and also rotatably connected to a securing rack; the drive may be subjected to an external force to slide relative to the securing rack, which drives the bolt to rotate, so that a snap hook of the bolt may access and exit a locking bore, whereby locking or unlocking is realized. A snap hook according to the disclosure may extend out of the locking bore to snap-fit the detachable attachment outside the housing, realizing positionally retaining of the bolt in multiple directions, which eliminates a need of additionally setting a limiting mechanism to extend the bolt outside of the housing to lock the detachable attachment, which facilitates use and offers a strong practicality.

### FIELD

The disclosure relates to a lock, and more particularly relates to a locking mechanism and a locking apparatus.

### BACKGROUND

With technological advancement, locking mechanisms have been flexibly applied in various types of machinery equipment, particularly in automobiles, medical instruments, toys, and door locks. As for a conventional locking mechanism, a locking bore is generally arranged on its housing, and a locking portion fitted with the locking bore is arranged on a movable member, so that by pushing the movable member, the locking portion may be fitted in the locking bore or migrate from the locking bore to thereby realize locking or unlocking. However, a majority of the conventional locking mechanisms can only realize locking between internal components of a product; irrespective of being in a locked state or a fastened state, the locking mechanism and a locked object are entirely exposed outside, which is not only aesthetic to users, but also limits application scope of the locking mechanism.

### SUMMARY

An object of the disclosure is to provide a locking mechanism and a locking apparatus, which can at least solve an issue that conventional locking mechanisms can only implement locking between internal components of a product.

To overcome the above and other problems, the disclosure is implemented in a manner described below:

According to one aspect, there is provided a locking mechanism, which is operable to securely lock a detachable attachment, wherein the locking mechanism comprises: a housing detachably connected to the detachable attachment, a securing rack mounted in the housing, a drive slidingly connected to the securing rack, and a bolt movably connected to the drive, a locking bore being formed on the housing, a first locating shaft being arranged on the securing rack, the bolt being rotatably connected to the first locating shaft, one end of the bolt distal from the first locating shaft being formed with a snap hook of a crooked shape, the snap hook being adapted to the locking bore, the drive being configured to drive the bolt to rotate about the first locating shaft from a first position to a second position, wherein when the bolt rotates to the first position, the snap hook is disposed inside the housing; and when the bolt rotates to the second position, one end of the snap hook extends out of the locking bore to securely lock the detachable attachment outside the housing.

As an improvement, wherein the drive comprises a push member in sliding fit with the securing rack, a transmission assembly rotatably connected to the push member, and a first transmission shaft connected to the transmission assembly and the bolt, the first transmission shaft being further connected to the securing rack in a sliding fit manner; and the bolt is formed with a first guiding hole adapted for the first transmission shaft to pass through, the first guiding hole being further configured to slidingly fit the first transmission shaft to enable the bolt and the securing rack to rotate relative to each other.

As an improvement, wherein a first torsion spring is further disposed on the first locating shaft in a sleeving manner, the first torsion spring being connected between the bolt and the securing rack; and the first torsion spring is configured to impose a reset force to drive the bolt to rotate so that the snap hook exits the locking bore.

As an improvement, wherein the transmission assembly comprises a first linkage rod rotatably connected to the first transmission shaft and a second linkage rod rotatably connected to one end of the first linkage rod distal from the first transmission shaft; one end of the second linkage rod distal from the first linkage rod is further rotatably connected to the push member via a second transmission shaft, and a second guiding hole adapted for the second transmission shaft to pass through is formed in the push member, the second guiding hole being configured to slidingly fit the second transmission shaft, a guiding direction of the second guiding hole being parallel to a direction opposite a sliding direction of the first transmission shaft; a second locating shaft is further rotatably connected between the first linkage rod and the securing rack, the first linkage rod being driven by the second linkage rod to rotate about the second locating shaft so as to drive the first transmission shaft to slide relative to the securing rack.

As an improvement, further comprising an elastic assembly mounted on the securing rack, the elastic assembly being configured to abut against the bolt when the bolt rotates to the second position.

As an improvement, wherein the elastic assembly comprises a third locating shaft connected to the securing rack, an abutment member sleeved on the third locating shaft, and a second torsion spring sleeved on the third locating shaft, the second torsion spring being connected between the securing rack and the abutment member, the second torsion spring being configured to impose an acting force against the abutment member in a direction towards the bolt.

As an improvement, wherein the elastic assembly further comprises a first manipulator connected to the abutment member, the first manipulator being subjected to an external force to drive the abutment member to rotate to migrate from the snap hook.

As an improvement, wherein a guide rod is mounted on the securing rack, the push member is sleeved on the guide rod, and a spring is further connected between the push member and the securing rack, the spring being sleeved on the guide rod.

As an improvement, wherein the push member comprises a push plate rotatably connected to the transmission assembly and a second manipulator connected to the push plate.

As an improvement, wherein the securing rack is further provided thereon with a baffle block having a shape adapted to the locking bore, a connecting block connected to the baffle block, and a rotary shaft connected between the connecting block and the push plate, a third guiding hole adapted for the rotary shaft to pass through being further provided in the securing rack, the third guiding hole being configured to slidingly fit the rotary shaft, a fourth guiding hole adapted for the rotary shaft to pass through being further provided in the push plate, the fourth guiding hole being configured to slidingly fit the rotary shaft, a guiding direction of the third guiding hole being different from that of the fourth guiding hole, the connecting block being configured to drive the baffle block to move as the push plate moves during an unlocking process so that the baffle block accesses the locking bore.

According to another aspect, there is provided a locking apparatus, comprising a detachable attachment and the locking mechanism according to the first aspect noted supra.

In view of the above, the locking mechanism and the locking apparatus according to the implementations of the disclosure offer the following benefits: the bolt is connected to the drive and also rotatably connected to the securing rack; the drive may be subjected to an external force to slide relative to the securing rack, which drives the bolt to rotate, so that the snap hook of the bolt may access and exit the locking bore, whereby locking or unlocking is realized. The snap hook according to the disclosure may extend out of the locking bore to snap-fit the detachable attachment outside the housing, realizing positionally retaining of the bolt in multiple directions, which eliminates a need of additionally setting a limiting mechanism to extend the bolt outside of the housing to lock the detachable attachment, which facilitates use and offers a strong practicality; in addition, by disposing the housing outside the structural components such as the securing rack and the bolt, it avoids the complex structural components from being directly exposed, improving the appearance of the locking mechanism.

### BRIEF DESCRIPTION OF THE DRAWINGS

FIG. 1 is an overall structural schematic diagram of a locking mechanism in an unlocked state according to some implementations of the disclosure;

FIG. 2 is an overall structural schematic diagram of a locking mechanism in a locked state according to some implementations of the disclosure;

FIG. 3 is a local structural schematic diagram of a locking mechanism according to some implementations of the disclosure;

FIG. 4 is a structural schematic diagram of a locking mechanism with removal of a housing and a push member in some implementations of the disclosure;

FIG. 5 is an overall structural schematic diagram of a bolt in some implementations of the disclosure;

FIG. 6 is an assembled diagram of a baffle plate, a connecting block, and a securing rack in some implementations of the disclosure; and

FIG. 7 is an exploded view of a locking mechanism in some implementations of the disclosure.

### DETAILED DESCRIPTION OF EMBODIMENTS

Hereinafter, the implementations of the disclosure will be described in detail. Example implementations are illustrated in the drawings, in which same or like reference numerals represent identical or similar elements or elements with identical or similar functions. The implementations described below with reference to the accompanying drawings are exemplary, intended for explaining, not limiting, the disclosure. All other implementations derived by a person of normal skill in the art based on those described herein without exercise of inventive efforts shall fall within the scope of protection of the disclosure.

It shall be understood that, in the description of the disclosure, the orientational or positional relationships indicated by the terms “central,” “longitudinal,” “transverse,” “length,” “width,” “width,” “upper,” “lower,” “front,” “rear,” “left,” “right,” “vertical,” “horizontal,” “top,” “bottom,” “inner,” “outer,” “clockwise,” “counterclockwise,” “axial,” “peripheral,” “radial,” and etc. are orientational and positional relationships based on the drawings, which are intended only for facilitating description of the disclosure and simplifying relevant illustrations, not for indicating or implying that the devices or elements compulsorily possess those specific orientations and are compulsorily configured and operated with those specific orientations; therefore, such terms should not be construed as limitations to the disclosure.

Besides, the terms “first” and “second” are only used for descriptive purposes, which shall not be construed as indicating or implying relative importance or implicitly indicating the quantity of a referred to technical feature. Therefore, the features limited by “first” and “second” may explicitly or implicitly include one or more of such features. In the implementations described herein, “plurality” indicates two or above, unless otherwise indicated.

### Implementation

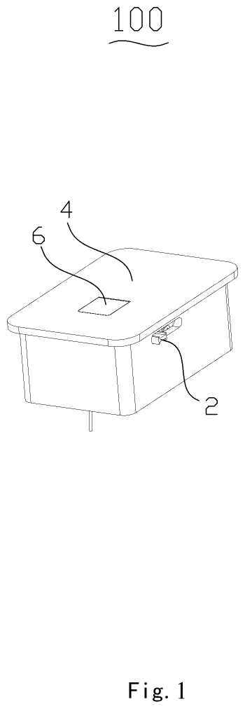

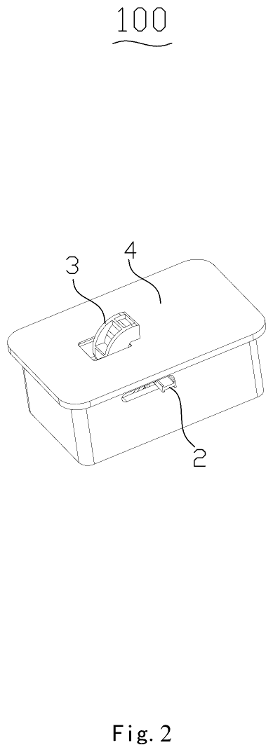

As illustrated in FIGS. 1-7, in this implementation, a locking mechanism 100 operable to securely lock a detachable attachment (not shown) comprises: a housing 4 detachably connected to the detachable attachment, a securing rack 1 mounted in the housing 4, a drive 2 slidingly connected to the securing rack 1, and a bolt 3 movably connected to the drive 2, a locking bore 41 being formed on the housing 4, a first locating shaft 31 being arranged on the securing rack 1, the bolt 3 being rotatably connected to the first locating shaft 31, one end of the bolt 3 distal from the first locating shaft 31 being formed with a snap hook 34 of a crooked shape, the snap hook 34 being adapted to the locking bore 41, the drive 2 being configured to drive the bolt 3 to rotate about the first locating shaft 31 from a first position (an unlocked position) to a second position (a locked position), where when the bolt 3 rotates to the first position, the snap hook 34 is disposed inside the housing 4, and when the bolt 3 rotates to the second position, one end of the snap hook 34 extends out of the locking bore 41 to securely lock the detachable attachment outside the housing 4.

Specifically, the bolt 3 is not only connected to the drive 2, but also rotatably connected to the securing rack 1; the drive 2 may slide relative to the securing rack 1 under an external force to drive the bolt 3 to rotate about the securing rack 1 to the second position or to the first position; when the bolt 3 rotates to the second position, the snap hook 34 passes through the locking bore 41 so as to be securely fitted in a locking slot of the detachable attachment; when the bolt 3 rotates to the first position, the snap hook 34 gradually migrates from the detachable attachment and the housing 4, whereby locking or unlocking of the locking mechanism 100 is realized. In this implementation, the snap hook 34 may pass through the locking bore 41 so as to be securely fitted in the locking slot of the detachable attachment outside the housing 4, thereby positionally retaining the bolt 3 in multiple directions; in this way, without additionally setting a limiting member, the snap hook 34 can extend out from the inside of the housing 4 to securely lock the detachable attachment, which facilitates a user in use with a wide array of applications.

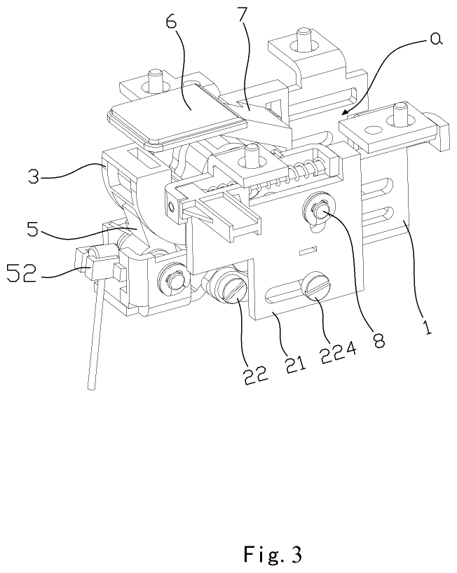

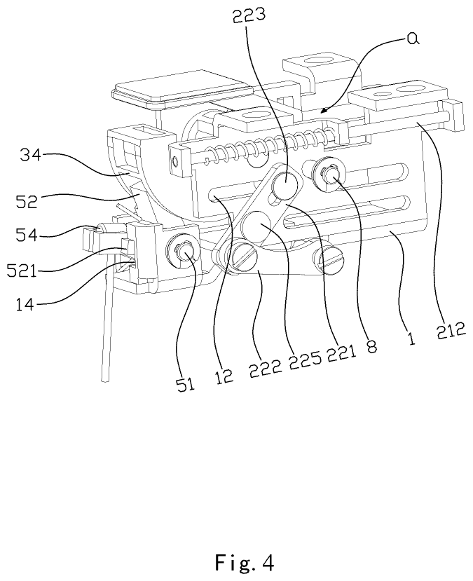

As illustrated in FIGS. 3 and 4, in this implementation, the drive 2 comprises a push member 21 slidingly fitted with the securing rack 1 and a transmission assembly 22 rotatably connected to the push member 21, the transmission assembly 22 being fitted with the bolt 3 via a first transmission shaft 223, the first transmission shaft 223 being also connected to the securing rack 1 in a sliding fit manner; the bolt 3 is further provided with a first guiding hole 33 through which the first transmission shaft 223 passes, the first guiding hole 33 being further slidingly fitted with the first transmission shaft 223 to enable the bolt 3 and the securing rack 1 to rotate relative to each other.

Specifically, the first transmission shaft 223 passes through the transmission assembly 22, the securing rack 1, and the bolt 3; the bolt 3 is provided with a first guiding hole 33 through which the first transmission shaft 223 passes, the first guiding hole 33 serving to limit position and direction of movement of the bolt 3, so that the bolt 3 and the securing rack 1 rotate relative to each other via sliding fit between the first guiding hole 33 and the first transmission shaft 223. A fifth guiding hole 12 adapted for the first transmission shaft 223 to pass through is formed on the securing rack 1, the fifth guiding hole 12 being configured to slidingly fit the first transmission shaft 223, the fifth guiding hole 12 serving to limit position and direction of movement of the first transmission shaft 223. A guiding direction of the fifth guiding hole 12 may be parallel to a push direction of the push member 21. To realize locking, a user may apply a push force against the push member 21 so that the push member 21 is pushed to slide relative to the securing rack 1, which drives the transmission assembly 22 to move; furthermore, the transmission assembly 22 may rotate relative to the first transmission shaft 223 to drive the first transmission shaft 223 to slide along the fifth guiding hole 12; meanwhile, the first transmission shaft 223 also slides relative to the first guiding hole 33 of the bolt 3, driving the bolt 3 to rotate relative to the securing rack 1, so that a tail end of the bolt 3 may pass through the locking bore 41, whereby the detachable attachment is locked.

It may be understood that, in some other implementations, no transmission assembly 22 is set for the drive assembly 2, i.e., the push member 21 may be directly connected to the first transmission shaft 223. With this setting, the first transmission shaft 223 may also slide relative to the fifth guiding hole 12 as the push member 21 moves, further driving the bolt 3 to rotate, finally realizing locking or unlocking of the locking member 100. The disclosure is not limited to such implementations.

Furthermore, in this implementation, the first locating shaft 31 is arranged between the securing rack 1 and the bolt 3, the securing rack 1 and the bolt 3 being rotatably connected via the first locating shaft 31; and a first torsion spring 32 is further sleeved on the first locating shaft 31, the first torsion spring 32 being connected between the bolt 3 and the securing rack 1, the first torsion spring 32 being configured to impose a reset force against the bolt 3, driving the bolt 3 to rotate about the first locating shaft 31 from the second position to the first position. In a specific example, the securing rack 1 is formed with a mounting space a which is open at an upper side and two ends thereof; in the unlocked state, the bolt 3 is disposed in the mounting space a. The first locating shaft 31 is connected to two sides of the securing rack 1, one end of the bolt 3 and the first torsion spring 32 being both sleeved on the first locating shaft 31, the first torsion spring 32 being connected between the bolt 3 and the securing rack 1. The first locating shaft 31 may serve as a rotating center, so that under guidance of the first transmission shaft 223, the bolt 3 may rotate about the first locating shaft 31. The first torsion spring 32 always imposes a reset force driving the bolt 3 to rotate about the first locating shaft 31 from the second position to the first position, i.e., when the user manipulates the elastic assembly 5 to dismiss the abutting force of the elastic assembly 5 against the bolt 3, the first torsion spring 32 may force the bolt 3 to automatically rotate from the second position to the first position (i.e., driving the bolt 3 to automatically switch from the locked state to the unlocked state), which offers an ingenious structural setting to facilitate use.

In this implementation, the transmission assembly 22 comprises a first linkage rod 221 rotatably connected to the first transmission shaft 223 and a second linkage rod 222 rotatably connected to one end of the first linkage rod 221 distal from the first transmission shaft 223, one end of the second linkage rod 222 distal from the first linkage rod 221 being further rotatably connected to the push member 21 via the second transmission shaft 224, a second guiding hole 2111 adapted for the second transmission shaft 224 to pass through being formed in the push member 21, the second guiding hole 2111 being slidingly fitted with the second transmission shaft 224, a guiding direction of the second guiding hole 2111 being parallel to a direction opposite a guiding direction of the fifth guiding hole 12; a second locating shaft 225 is further rotatably connected between the first linkage rod 221 and the securing rack 1, the first linkage rod 221 being driven by the second linkage rod 222 to rotate about the second locating shaft 225 so as to drive the first transmission shaft 223 to slide along the fifth guiding hole 12. That is to say, the transmission assembly 22 may drive the first transmission shaft 223 to move in a direction opposite a movement direction of the push member 21, so that the bolt 3 may rotate via mutual fitting between the first transmission shaft 223 and the first guiding hole 33.

As illustrated in FIG. 3˜5 and 7, in this implementation, the locking mechanism 100 further comprises an elastic assembly 5 mounted on the securing rack 1, the elastic assembly 5 being configured to abut against different portions of the bolt 3 when the bolt rotates to the second position and the first position, respectively, where when the bolt 3 rotates to the second position, the snap hook 34 projects outside the housing 4 to securely snap-fit the detachable attachment; and when the bolt 3 rotates to the first position, the snap hook 34 migrates from the housing 4.

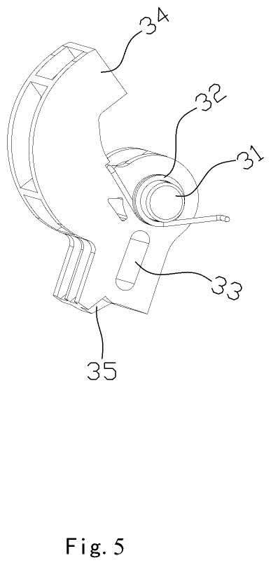

Specifically, as illustrated in FIG. 5, an abutment portion 35 is arranged on an outer peripheral side of the bolt 3 at an interval, a side where the abutment portion 35 is located being opposite a snap-fitting side of the snap hook 34. When the snap hook 34 projects out of the locking bore 41 till securely snap-fitting the detachable attachment outside the housing 4, the elastic assembly 5 may abut against the abutment portion 35, whereby locking stability of the locking member 100 is enhanced.

Furthermore, as illustrated in FIGS. 3, 4, and 7, in this implementation, the elastic assembly 5 comprises a third locating shaft 51 connected to the securing rack 1, an abutment member 52 sleeved on the third locating shaft 51, and a second torsion spring 53 sleeved on the third locating shaft 51, the second torsion spring 53 being connected between the securing rack 1 and the abutment member 52, the second torsion spring 53 being configured to apply an acting force against the abutment member 52 in a direction towards the bolt 3. That is, due to provision of the second torsion spring 53, the elastic assembly 5 always applies an acting force towards the bolt 3; in a need of unlocking, an external force may be applied so that the abutment member 52 rotates in a direction away from the bolt 3; when the abutment member 52 migrates from the bolt 3, under the action of the first torsion spring 32, the bolt 3 may automatically rotate from the second position to the first position (i.e., switching from the locked state to the unlocked state), whereby quick unlocking is realized.

In a specific example, the elastic assembly 5 further comprises a first manipulator 54 connected to the abutment member 52, the first manipulator 54 being subjected to an external force to drive the abutment member 52 to rotate to migrate from the bolt 3. The first manipulator 54 may be a pull wire attached to the abutment member 52 or a projection integrally attached to the abutment member 52, so that the user may actuate the abutment member 52 to rotate about the third locating shaft 51 by pulling the pull wire or deflecting the projection, whereby the abutment member 52 migrates from the abutment portion 35 to realize unlocking. During the process of the bolt 3 rotating from the first position to the second position, the outer peripheral side of the bolt 3 slides relative to the abutment member 52 till securely abutting against the abutment member 52, i.e., during the process of locking, the user only needs to manipulate the push member 21, which is convenient in use. In addition, as illustrated in FIG. 4, the abutment member 52 is further provided with a limiting projection 521, and a limiting recess 14 in limiting-fit with the limiting projection 521 is formed on the securing rack 1, i.e., the limiting projection 521 on the elastic assembly 5 is limited in the limiting recess 14 of the securing rack 1; under the action of the second torsion spring 53, the limiting projection 521 of the elastic assembly 5 always contacts an upper surface of the limiting recess 14; in the locked state, the abutment portion 35 of the elastic assembly 5 abuts against the bolt 3; and in the unlocked state, the elastic assembly 5 does not contact the bolt 3.

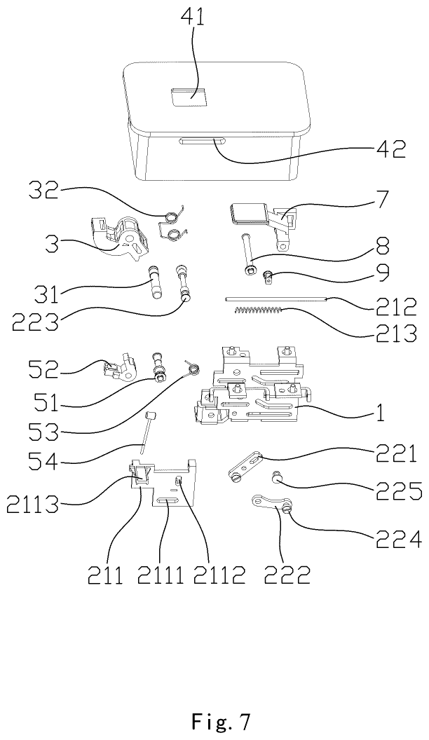

As illustrated in FIGS. 4 and 7, in this example, a guide rod 212 is mounted on the securing rack 1, a spring 213 is sleeved on the guide rod 212, the push member 21 is sleeved on the guide rod 212, and the spring 213 is located between the push member 21 and the securing rack 1. The guide rod 212, the spring 213, and the push member 21 are all arranged at one side of the securing rack 1, and a lengthwise extension direction of the guide rod 212 may be parallel to a guiding direction of the fifth guiding hole 12, i.e., the transmission assembly 22 may drive the first transmission shaft 223 connected to the bolt 3 to slide in a direction opposite the movement direction of the push member 21, so that the first transmission shaft 223 drives the bolt 3 to rotate. The direction of the elastic force imposed by the spring 213 against the push member 21 is identical to the guiding direction of the fifth guiding hole 12. In a need of unlocking, the user just pulls the first manipulator 54 so that the abutment member 52 migrates from the bolt 3, and the elastic force imposed by the spring 213 would drive the push member 21 to automatically reset to the initial position (i.e., the position in the unlocked state); meanwhile, the push member 21 also drives relevant components of the transmission assembly 22 to automatically reset to the initial state, thereby implementing quick unlocking. Furthermore, in this example, the push member 21 comprises a push plate 211 rotatably connected to the transmission assembly 22 and a second manipulator 2113 connected to the push plate 211. The second manipulator 2113 may be a projection integrally attached to the push plate 211 to facilitate the user's push operation.

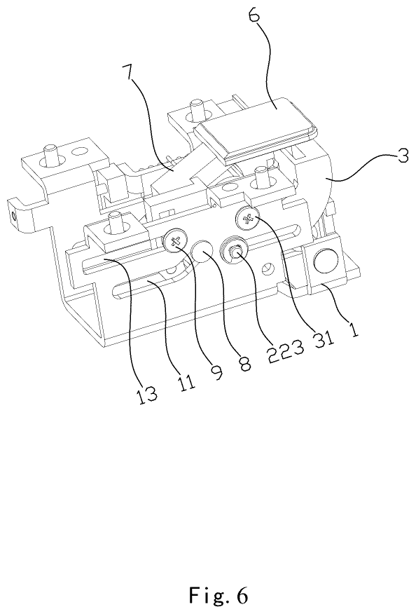

As illustrated in FIGS. 6 and 7, in this example, a baffle block 6 having a shape adapted to the locking bore 41 and a connecting block 7 connected to the baffle block 6 are further mounted on the securing rack 1, the connecting block 7 being connected to the securing rack 1 and the push plate 211 via a rotary shaft 8; a third guiding hole 11 through which the rotary shaft 8 passes is further provided in the securing rack 1, the third guiding hole 11 being slidingly fitted with the rotary shaft 8, and a fourth guiding hole 2112 through which the rotary shaft 8 passes is further provided on the push plate 211, the fourth guiding hole 2112 being slidingly fitted with the rotary shaft 8, a guiding direction of the third guiding hole 11 being different from that of the fourth guiding hole 2112; the connecting block 7 drives the baffle block 6 to move as the push plate 211 moves during the unlocking process, whereby the baffle block 6 enters the locking bore 41.

Specifically, the baffle block 6 and the connecting block 7 may be integrally connected. The push plate 211 in movement may drive the connecting block 7 to move synchronously. During this process, under the guidance of the third guiding hole 11 and the fourth guiding hole 2112, the connecting block 7 may also rotate by a certain angle relative to the securing rack 1 so that the baffle block 6 may smoothly access and exit the locking bore 41. In some examples, a sixth guiding hole 13 spaced from the third guiding hole 11 may also be provided in the securing rack 1, the securing rack 1 and the connecting block 7 being connected via a guiding shaft 9, i.e., the guiding shaft 9 passes through the sixth guiding hole 13 to engage the connecting block 7, which may further enhance stability of the connecting block 7. In the unlocked state, the baffle block 6 may enter the locking bore 41, in which case a surface of the baffle block 6 is in flush with a surface of the housing; to lock, the push member 21 in movement may drive the connecting block 7 to move so that the baffle block 6 automatically retracts into the housing; this structural setting is not only ingenious but also enhances the overall aesthetic appearance of the locking mechanism 100.

As illustrated in FIGS. 1 through 7, in this implementation, a locking apparatus comprises a detachable attachment and a locking mechanism 100 detachably connected to the detachable attachment. The detachable attachment may be a vehicle engine hood or other devices that need locking, which is not limited herein. A locking bore 41 and an avoidance opening 42 may be formed on the housing 4. A position and a shape of the locking bore 41 are adapted to those of the snap hook 34 of the bolt 3; and a locking slot having a shape adapted to the snap hook 34 may also be provided on the detachable attachment so that the snap hook 34 may pass through the locking bore 41 so as to securely snap-fitted with the locking slot, which realizes locking between the detachable attachment and the locking mechanism 100. A position and a shape of the avoidance opening 42 are adapted to those of the second manipulator 2113, and a guiding surface in sliding fit with a second manipulator 2113 is further formed on the avoidance opening 42, one end of the second manipulator 2113 distal from the push plate 211 passes through the avoidance opening 42 to extend outside the housing, which facilitates the user's manipulation. Many conventional locking mechanisms 100 can only implement locking between internal components of a product; in contrast, the locking mechanism 100 according to this implementation allows for the bolt 3 to extend out of the housing 4 to lock the detachable attachment, which offers an ingenious structural setting, a convenient operation, and an aesthetic appearance.

What have been described supra are only examples of the disclosure, which are not intended for limiting the disclosure; any modification, equivalent substitution, and revision made within the spirit and scope of the disclosure shall fall within the scope of protection of the disclosure.

I/We claim:

1. A locking mechanism, which is operable to securely lock a detachable attachment, wherein the locking mechanism comprises: a housing detachably connected to the detachable attachment, a securing rack mounted in the housing, a drive slidingly connected to the securing rack, and a bolt movably connected to the drive, a locking bore being formed on the housing, a first locating shaft being arranged on the securing rack, the bolt being rotatably connected to the first locating shaft, one end of the bolt distal from the first locating shaft being formed with a snap hook of a crooked shape, the snap hook being adapted to the locking bore, the drive being configured to drive the bolt to rotate about the first locating shaft from a first position to a second position, wherein when the bolt rotates to the first position, the snap hook is disposed inside the housing; and when the bolt rotates to the second position, one end of the snap hook extends out of the locking bore to securely lock the detachable attachment outside the housing.

2. The locking mechanism according to claim 1, wherein the drive comprises a push member in sliding fit with the securing rack, a transmission assembly rotatably connected to the push member, and a first transmission shaft connected to the transmission assembly and the bolt, the first transmission shaft being further connected to the securing rack in a sliding fit manner; and the bolt is formed with a first guiding hole adapted for the first transmission shaft to pass through, the first guiding hole being further configured to slidingly fit the first transmission shaft to enable the bolt and the securing rack to rotate relative to each other.

3. The locking mechanism according to claim 2, wherein a first torsion spring is further disposed on the first locating shaft in a sleeving manner, the first torsion spring being connected between the bolt and the securing rack; and the first torsion spring is configured to impose a reset force to drive the bolt to rotate so that the snap hook exits the locking bore.

4. The locking mechanism according to claim 2, wherein the transmission assembly comprises a first linkage rod rotatably connected to the first transmission shaft and a second linkage rod rotatably connected to one end of the first linkage rod distal from the first transmission shaft; one end of the second linkage rod distal from the first linkage rod is further rotatably connected to the push member via a second transmission shaft, and a second guiding hole adapted for the second transmission shaft to pass through is formed in the push member, the second guiding hole being configured to slidingly fit the second transmission shaft, a guiding direction of the second guiding hole being parallel to a direction opposite a sliding direction of the first transmission shaft; a second locating shaft is further rotatably connected between the first linkage rod and the securing rack, the first linkage rod being driven by the second linkage rod to rotate about the second locating shaft so as to drive the first transmission shaft to slide relative to the securing rack.

5. The locking mechanism according to claim 1, further comprising an elastic assembly mounted on the securing rack, the elastic assembly being configured to abut against the bolt when the bolt rotates to the second position.

6. The locking mechanism according to claim 5, wherein the elastic assembly comprises a third locating shaft connected to the securing rack, an abutment member sleeved on the third locating shaft, and a second torsion spring sleeved on the third locating shaft, the second torsion spring being connected between the securing rack and the abutment member, the second torsion spring being configured to impose an acting force against the abutment member in a direction towards the bolt.

7. The locking mechanism according to claim 6, wherein the elastic assembly further comprises a first manipulator connected to the abutment member, the first manipulator being subjected to an external force to drive the abutment member to rotate to migrate from the snap hook.

8. The locking mechanism according to claim 2, wherein a guide rod is mounted on the securing rack, the push member is sleeved on the guide rod, and a spring is further connected between the push member and the securing rack, the spring being sleeved on the guide rod.

9. The locking mechanism according to claim 2, wherein the push member comprises a push plate rotatably connected to the transmission assembly and a second manipulator connected to the push plate.

10. The locking mechanism according to claim 9, wherein the securing rack is further provided thereon with a baffle block having a shape adapted to the locking bore, a connecting block connected to the baffle block, and a rotary shaft connected between the connecting block and the push plate, a third guiding hole adapted for the rotary shaft to pass through being further provided in the securing rack, the third guiding hole being configured to slidingly fit the rotary shaft, a fourth guiding hole adapted for the rotary shaft to pass through being further provided in the push plate, the fourth guiding hole being configured to slidingly fit the rotary shaft, a guiding direction of the third guiding hole being different from that of the fourth guiding hole, the connecting block being configured to drive the baffle block to move as the push plate moves during an unlocking process so that the baffle block accesses the locking bore.

11. A locking apparatus, comprising a detachable attachment and the locking mechanism according to claim 1.
